(19) United States
(12) Patent Application Publication
(10) Pub. No.: US 2006/0222820 A1
(43) Pub. Date: Oct. 5, 2006

(54) Bonding sheet made of hot-melt adhesive, and method producing and using the same

(76) Inventor: Wen-Chung Liu, Da-Li City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/091,496

(22) Filed: Mar. 29, 2005

(51) Int. Cl. B32B 1/00

(52) U.S. Cl. 428/174; 428/343

(57) ABSTRACT

The present invention relates to a kind of bonding sheet made of hot-melt adhesive, by introducing its production method and way to glue, shape and bond two items. It is first to prepare a female die and a male die for producing the bonding sheet, which can be used to glue and bond the items. It is then made as follows: first prepare the hot-melt adhesive; then heat it to be melting; fill the melting hot-melt adhesive into the female die cavity via adding pressure; press the male and female dies to mount together; and finally cool it down to get the bonding sheet with hot-melt adhesive as composition. This sheet can be attached to the place where the two items are to be bonded, and glue the items through proper heating and pressing. After cooling down, it can be bonded with the items and become solid to bond and shape the two items, and eventually achieves the objective of convenient production and environmental protection.

### BACKGROUND OF THE INVENTION

1. Field of the Invention

The present invention relates to a bonding sheet made of hot-melt adhesive, by introducing its production method and way to glue, shape and bond two items, particularly to a bonding sheet which has a stereo shape with an arch surface and is made of hot-melt adhesive, together with its production method. The present invention also relates to the method of attaching the bonding sheet to the place where the two items are to be bonded, and adhering itself between the two items for bonding and shaping. This invention can achieve the objective of convenient production, cost saving and environmental protection.

2. Description of Related Art

It has been noted that for two items of supple materials to be attached, in order to properly increase the bonding strength between the two items and ensure the round corner of the two items to obtain stable fixiform and bonding, all currently existing technologies prefer to place a bonding sheet in the inter space at the round corner of the two items. Due to the bonding sheet's proper strength and its similar round-corner shape to those of the two items to be bonded, it can be used to support and fix the round corner of the two items which are made of supple materials. Wherein, two items have to be glued so tightly to form an integrated finished product as by existing technologies. Since existing bonding sheets are usually ejaculated and formed by non-adhesive materials like PVC (such as the easily seen bonding sheet of shoe heel, to realize the conventional glued status of the two items after placing the bonding sheet between them, it is usually to first smear toluene onto the PVC bonding sheet surface for a proper degree of erosion of the surface, and then smear glue onto the eroded surface, and finally place the bonding sheet between the two items for adherence. However, these existing technologies are not only complicated and inconvenient in operation, but also easily to induce pollution because of the PVC which is hard to decompose.

There have been in the market some types of inflammable and nontoxic hot-melt adhesives, which can be melted at low temperature (the typical melting point is between 65° C.˜180° C.), have the functionality of environmental protection and will not form embrittlement cracking after cooling down. The adhesives of these usual types subsume the following compositions: high molecular weight polymer, synthetic elastomer and resin. All types of hot-met adhesives, though different in their chemical composition corresponded to different actual application demands, mainly share the often used Vinyl Polymers, which has the chemical formula combined with ethylene and its heterobaric copolymers, amorphous polypropylenes and thermoplastic rubbers. For instance, a traditional hot-melt adhesive is composed of ethylene, vinyl acetate and some additives, such as thermoplastic polymers and waxes, etc. The above often used hot-melt adhesives, though have already been possessed of many advantages, have not employed the technology of pre-modelling the hot-melt adhesive in accordance with the shaping site where the items are attached. Conventional hot-melt adhesives are pressed into the shapes of bar, slice or cylinder during production, it is thus necessary for users to mop hot-melt adhesive onto the items for adhesiveness, which however increases the inconvenience in utilization and the cost of machine facilities.

### SUMMARY OF THE INVENTION

The objective of this invention is to provide a kind of bonding sheet made of hot-melt adhesive and with this invention, the bonding and shaping process on the items being bonded is much simpler. It also applies the technology of reducing environmental pollution. The bonding sheet is made to have a stereo shape with an arch surface complying with the items to be bonded, directly using hot-melt adhesive die. It includes preparing a female die and a male die for producing the bonding sheet first, which can be used to glue and bond the items. It is then made as follows: first prepare the hot-melt adhesive; then heat it to be melting; fill the melting hot-melt adhesive into the female die cavity via adding pressure; press the male and female dies to mount together; and finally cool it down to get the bonding sheet with hot-melt adhesive as composition. As for the bonding method, such sheet can be attached to the place where the two items are to be bonded, and glue the items through proper heating and pressing. After cooling down, it can be bonded with the items and become solid to bond and shape the two items, and eventually achieves the objective of convenient production and environmental protection.

### BRIEF DESCRIPTION OF THE DRAWINGS

FIG. 1 is a flow chart of the present invention;

FIG. 2 is a flow chart of the preferred embodiment of the present invention;

FIG. 3 shows the schematic view of the complete device of the present invention;

FIG. 4 shows the schematic view of the mold mounting of the male fixture die and the female fixture die;

FIG. 5 shows the schematic view of the female mold moved beneath the male mold;

FIG. 6 shows the schematic view of the mold mounting of the female and male molds;

FIG. 7 shows the schematic view of the finished bonding sheet; and

FIG. 8 shows the schematic view of the application of the shoe heel bonding sheet in a shoe.

### DETAILED DESCRIPTION OF THE PREFERRED EMBODIMENT

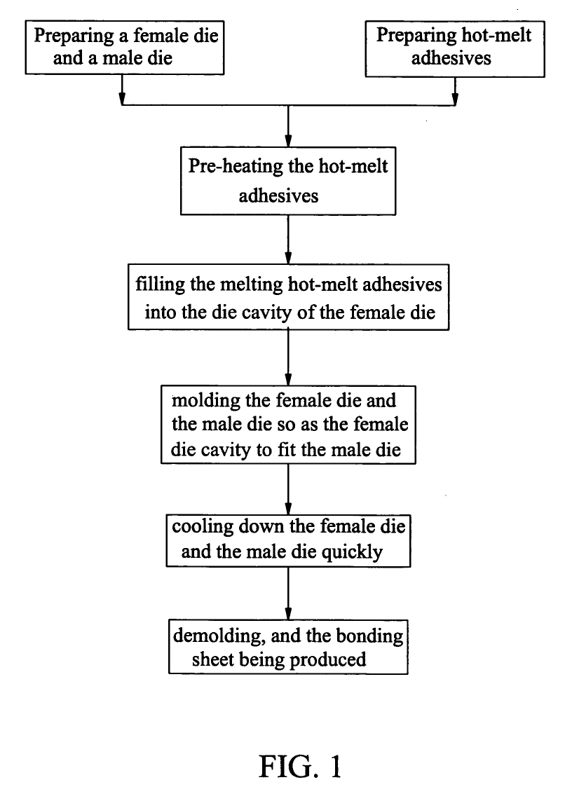

Refer to FIG. 1 for the method of the present invention, which includes the following steps:

preparing a female die having a plurality of die cavities and a male die having a plurality of protruding parts for producing the bonding sheet, which has a stereo shape with a bended surface;

preparing hot-melt adhesives that are used as the materials of bond sheets;

pre-heating hot-melt adhesives to 65□˜200□ till they are melting;

filling the melting hot-melt adhesives with pressure into the plurality of die cavities of the female die;

molding the female die and the male die so that the plurality of the die cavities of the female to fit the plurality of protruding parts of the male die;

cooling down quickly; and demolding, and the bonding sheet made of hot-melt adhesive being finished.

The bonding sheet made of hot-melt adhesive of the present invention, having no any other layers made of other material, comprises a stereo shape with an arch surface, and at least one side of the bonding sheet complies with the place where the items are to be bonded.

In a particular embodiment, the hot-melt adhesive includes one or more of the TONE P-700, TONE P-767, or TONE P-787 polycaprolactone polymers manufactured by UNION CARBIDE CORPORATION, singly or in any combination. The polycaprolactone polymer may have the formula: 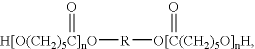
where R is an aliphatic hydrocarbon.

The TONE set of polycaprolactone polymers or other aliphatic polyesters are disclosed in U.S. Pat. No. 5,112,225 and U.S. Pat. No.4,784,123, and in product literature distributed by UNION CARBIDE CORPORATION, as including homopolymers, block copolymers, graft copolymers, or other polymers containing epsilon-caprolactone. Polymerization may be initiated using a diol, for example and without limitation, ethylene glycol, diethylene glycol, neopentyl glycol, butane diol, hexane diol, or any other appropriate diol. The diol may have the formula: HO—R—OH, where R is an aliphatic hydrocarbon. The aliphatic polyesters may have the formula: 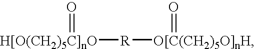
where R is an aliphatic hydrocarbon.

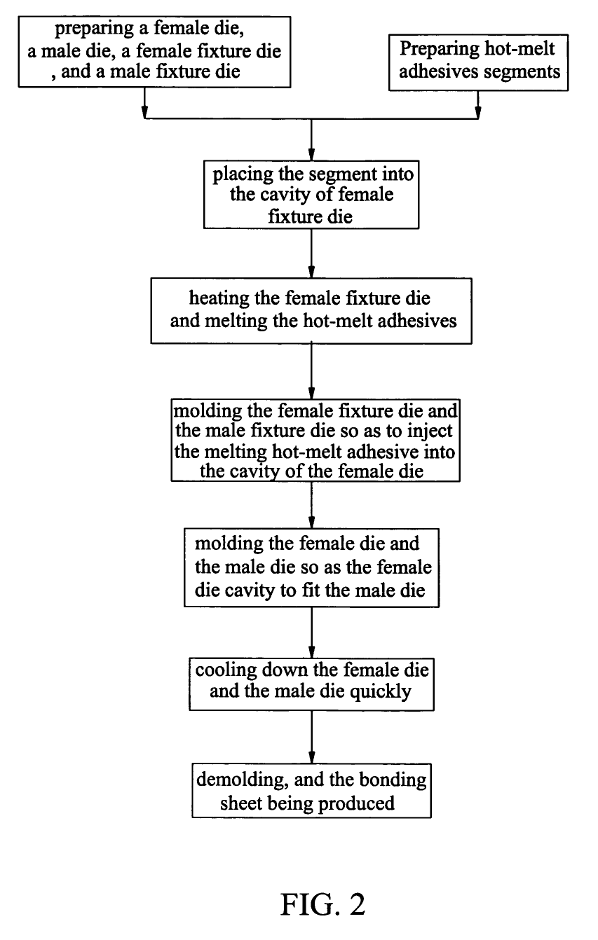

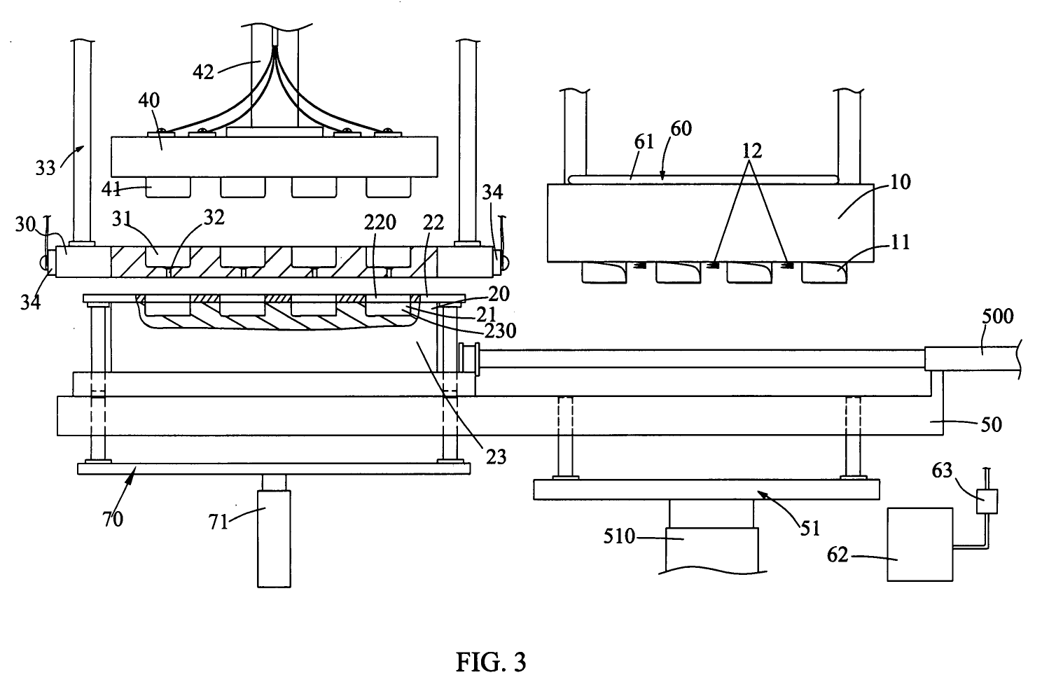

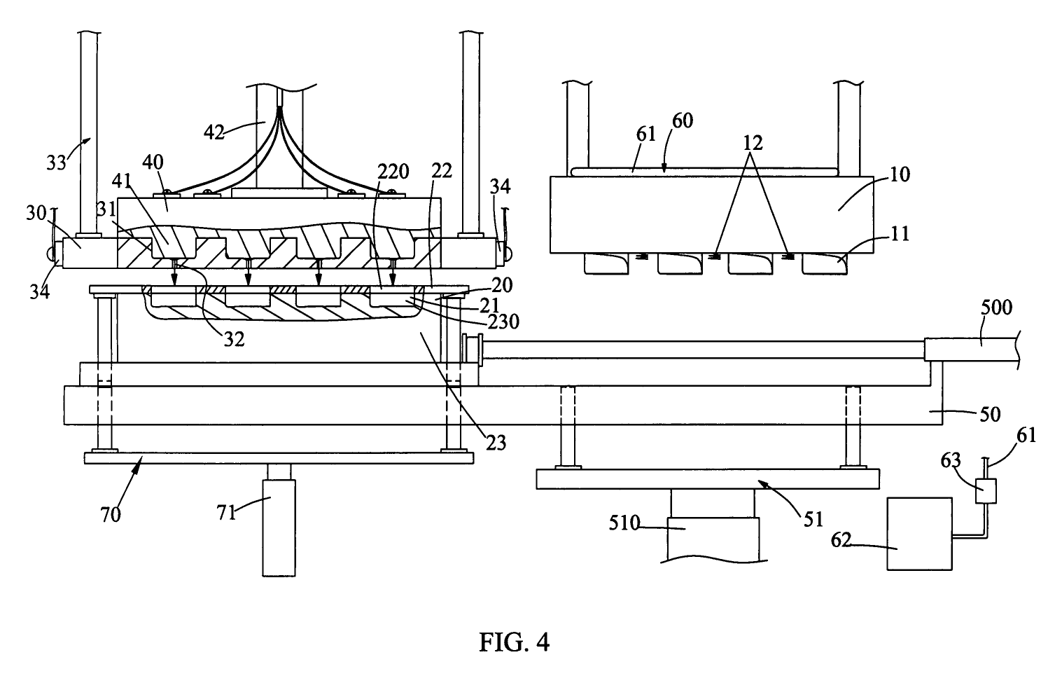

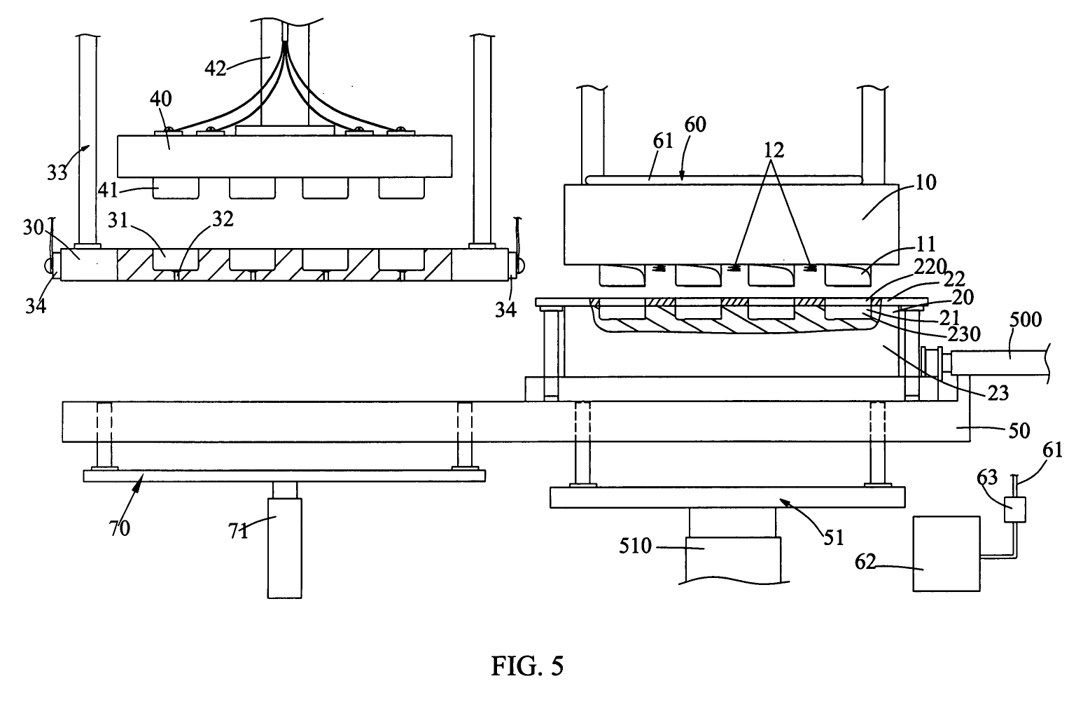

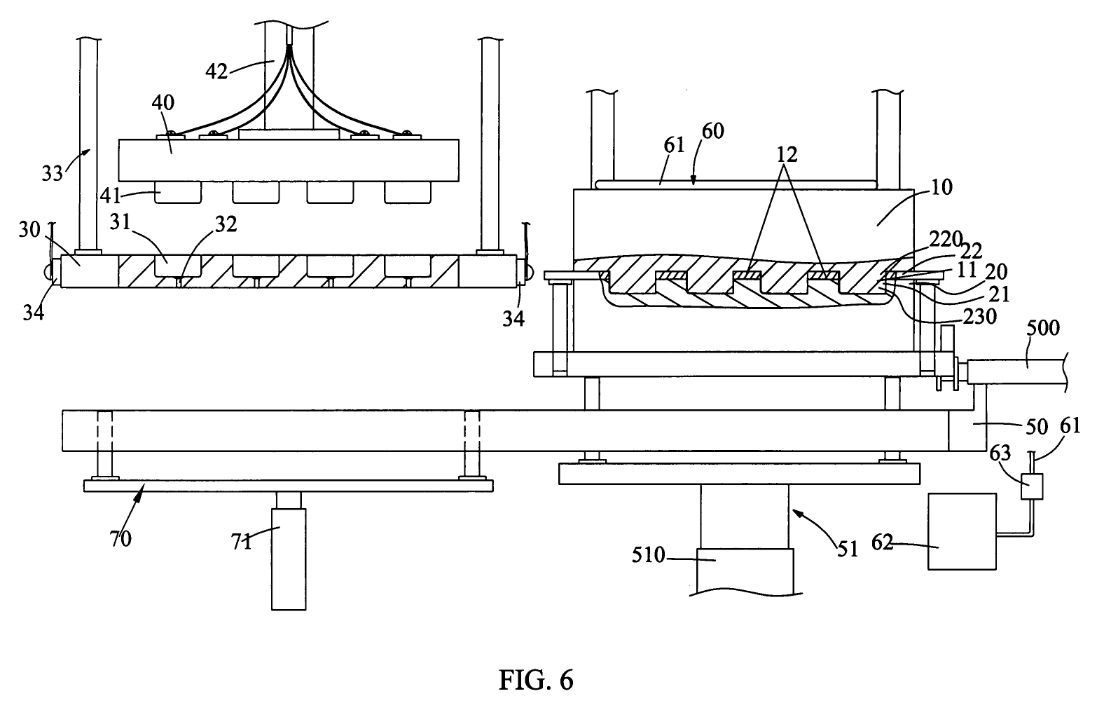

As shown in FIG. 2 to 6, in the preferred embodiment of the present invention of adhesive bonding sheet, the hot-melt adhesives prepared is cut into solid segments, and the way to heat and fill the hot-melt adhesive into the plurality of die cavities of the female die is as follows: (a)put the solid segments of hot-melt adhesive one after another into the cavities 31 of a female fixture die 30; (b)after heating the female fixture die 30 and melting the hot-melt adhesive, place the protruding parts 41 of a male fixture die 40 into the cavities 31 of the female fixture die 30; (c)through pressing upon them, the melting hot-melt adhesive is injected into each of cavities 21 of the beneath female die 20, through the interpenetrated cavities 31 of the female fixture die 30. By this way, the quality of finished products can be controlled.

Furthermore, another preferred embodiment of the present invention is to store the melting hot-melt adhesive prepared in a filling instrument which does not show as figures, while the way to fill the hot-melt adhesive is to heat them in the filling instrument and then to inject them into each cavity of the female die. This approach allows the operator to fill hot-melt adhesive in an automatic manner.

As one preferred embodiment of the present invention, the prepared hot-melt adhesive is mixed with a plurality of segments of fiber to increase the bonding strength of the bonding sheet.

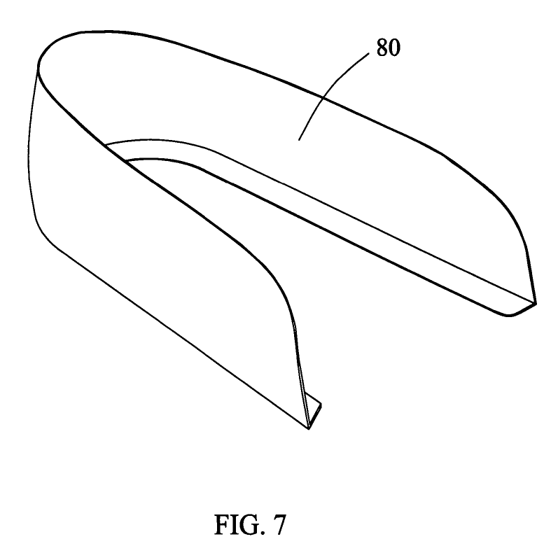

Take the shoe-heel bonding sheet as an example, with the complement of FIG. 2˜6, the method of this invention is as the following: (a)First prepare a female die 20 having a plurality of die cavities 21 and a male die 10 having a plurality of protruding parts 11 that can produce shoe-heel bonding sheets which will be mainly placed between the shoe surface and the shoe lining; (b)And prepare hot-melt adhesive segments that are used as materials of bond sheets; (c)And then fill each hot-melt adhesive segment one after another into each of cavities 31 of the female fixture die 30, and heat the female fixture die 30 using the electric heating plates 34 to around 120□; (d)At that time the hot-melt adhesives in cavities 31 of the female fixture die 30 are melting, the protruding part 41 of a male fixture die 40 is to be pressed into the cavities 31 of the female fixture die 30 using the first and second lifting devices 33, 42, which will further press the melting adhesive downward, and inject them into the cavities 21 of the beneath female die 20 through the downward connecting through-hole 32 of the cavities 31 of the female fixture die 30; (e)And then push the female die 20 toward the underside of the male die 10 using the oil hydraulic cylinder 500 of the horizontal movement device 50, and then actuate the female die 20 upward to mount with the male die 10 using the oil hydraulic cylinder 510 of the mounting device 51; (f)After quickly cooling down the male die 10 and the female die 20 using the cooling device 60, bonding sheets 80 composite of hot-melt adhesive can be demolded and become finished (See FIG. 7).

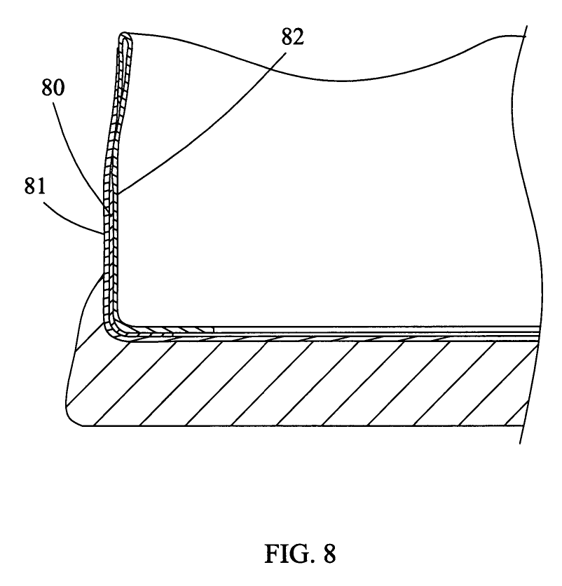

During the end section of producing the above mentioned shoe-heel bonding sheets in the way proposed by the present invention, the bonding sheets 80 can be placed at the inter space between the shoe surface 81 and shoe lining 82 to bond these two together (as shown in FIGS. 7 and 8), so as to make the two sides of the sheet attach and match with the shoe surface 81 and the shoe lining 82. And then it is to heat the shoe surface 81 and the shoe lining 82 as well as the bonding sheet 80 to 65□˜200□ (the one chosen for the preferred embodiment is 100□) and enforce the pressure of 30˜100 kg per square centimeter (the one chosen for the preferred embodiment is 60, so as to make the surface of the bonding sheet 80 a little bit melting and adhesive, which then allows the shoe surface 81 to fuse with the shoe lining 82. After cooling down, the bonding sheet 80 can not only adhere with the shoe surface 81 and the shoe lining 82, but also can be sclerotic and shaped in the strengthened place between the shoe surface 81 and the shoe lining 82.

The present invention, the bonding sheet 80 as shown in FIG. 7, is particularly made of hot-melt adhesive and has at least one of its side matches in shape with the item to be boned. The hot-melt adhesive of the bonding sheet 80 mainly contains high molecular weight Polymer, synthetic elastomer and resin. The polymer further subsumes oxycarbonyl and pentamethylene. Moreover, a plurality of segments of fiber is mixed into the hot-melt adhesive to increase the bonding strength of the bonding sheet.

As shown in FIGS. 2˜6, the devices used by the present invention for producing bonding sheets include:

a male die 10 having a plurality of protruding parts 11 with an bended surface that can produce bonding sheets;

a female die 20 having a plurality of cavities 21 with an bended surface that can produce bonding sheets;

a female fixture die 30 having a plurality of cavities 31, with a downward connecting through-hole underneath;

a male fixture die 40 having a plurality of protruding parts 41 which complies with the plurality of die cavities 31 of the female fixture die 30;

a first lifting device 33 powered by a oil cylinder, coupled with the female fixture die 30 and able to actuate the step-up & down of the female fixture die 30;

a second lifting device 42 powered by a oil cylinder, coupled with the male fixture die 40 and able to actuate the step-up & down of the male fixture die 40;

a plurality of electric heating plates 34 placed on the female fixture die 30, useful for heating the female fixture die 30;

horizontal movement device 50 powered by the oil cylinder 500, for actuating the female die 20 and moving it toward the underside of the male die 10;

mounting device 51 powered by the oil cylinder 510, for actuating the male die 10 and mounting it with the female die 20;

and the cooling device 60 on one side of the mounting device 51, for cooling down the bonding sheets inside the cavities 21 of the female die 20.

As for the preferred embodiment of the present invention, the female die 20 contains an upper half die 22 and a lower half die 23, the upper half die 22 has a plurality of cavities 220 penetrated, the lower half die 23 has a plurality of cavities 230 opened upward. The two cavities 220, 230 of the two dies 22, 23 can be combined into a complete cavities 21 mounting the protruding parts 11 of the male die 10. And the upper half die 22 is actuated to step up and down by the oil cylinder of the third lifting device 70. To implement the invention, the springs 12 set between the male die 10 and the upper half die 22 can force the upper half die 22 to tightly close to the lower half die 23 when the male die 10 and the female die 20 are mounting, so as to avoid extra fuzzy edges shown in the finished product.

As for the preferred embodiment of the present invention, the cooling tubes 61 of the cooling device 60 are deployed on the male die 10 and the female die 20, connecting the coolant flow container 62 and the pump 63. The pump 63 diverts the coolant flow from the container 62 to the cooling tubes 61, which can cool down the male die 10 and the female die 20.

As for the preferred embodiment of the present invention, the cooling device is a Nitrogen nozzle. It connects the Nitrogen container and the pump, and spouts Nitrogen onto the male and female dies for cooling using the pump, which, however, does not show as figures.

The above is the detailed description of the technical characteristics of this invention based on the instance that is implemented quite well. However, experts familiar with this technique are allowed to change and modify this invention as long as they do not depart from the sprit and principle of this invention, but this change and modification should be confined in the following scopes defined by the applied patent.

What is claimed is:

1. A bonding sheet made of hot-melt adhesive, has no any other layers made of other material, comprises a stereo shape with an arch surface, and at least one side of the bonding sheet complies with the place where the items are to be bonded.

2. The structure as claimed in claim 1, wherein within the bonding sheet made of hot-melt adhesive a plurality of segments of fiber are mixed.

3. The structure as claimed in claim 1, wherein the hot-melt adhesive of the bonding sheet comprises polycaprolactone polymer.

4. A production method of bonding sheet made of hot-melt adhesive and used to glue and shape two items, which includes:
preparing a female die having cavities and a male die having protruding parts for producing the bonding sheet having a stereo shape with a bended surface.
preparing hot-melt adhesives that are used as the materials of bond sheets;
heating hot-melt adhesives to 65□˜200□ till being melted;
filling the melting hot-melt adhesives with pressure into the die cavity of the female die;
molding the female die and the male die so that the plurality of the die cavities of the female to fit the plurality of protruding parts of the male die;
cooling down the female die and the male die quickly; and
demolding, and the bonding sheet made of hot-melt adhesive being finished.

5. The method as claimed in claim 4, wherein the prepared hot-melt adhesive is mixed with a plurality of segments of fiber in it.

6. The method as claimed in claim 4, wherein the method to heat and fill the hot-melt adhesive into the female die cavity includes:
putting the solid segments of hot-melt adhesive into the cavity of a female fixture die;
heating the female fixture die and melting the hot-melt adhesive; and
molding the female fixture die and the male fixture die so as the protruding part of a male fixture die to place into the cavity of the female fixture die, and pressing the melting hot-melt adhesive to be injected into the cavity of the beneath female die through the interpenetrated cavity of the female fixture die.

7. The method as claimed in claim 4, wherein the melting hot-melt adhesive prepared is stored in a filling instrument, while the way to fill the hot-melt adhesive in is to heat them in the filling instrument and then to inject them into each cavity of the female die.

8. A bonding method by using bonding sheets as claimed in claim 1 to glue and shape two items, comprises:
attaching a bonding sheet at the place where the items are to be bonded;
heating the items and bonding sheet to 65□˜200□ and enforce the pressure of 30˜100 kg per square centimeter, so as to make the surface of the bonding sheet a little bit melting and adhesive to the items; and cooling down so as the bonding sheet to be glued to the items.

9. The structure as claimed in claim 8, wherein the two items to be bonded are the shoe surface and the shoe lining, the bonding method by using bonding sheets to glue and shape the shoe surface and the shoe lining, comprises:
placing the bonding sheets at the inter space between the shoe surface and the shoe lining to bond these two together, so as to make the two sides of the sheet attach and match with the shoe surface and the shoe lining;
heating the shoe surface and the shoe lining as well as the bonding sheet to 65□˜200□ and enforcing the pressure of 30˜100 kg per square centimeter, so as to make the surface of the bonding sheet a little bit melting and adhesive and to allow the shoe surface to fuse with the shoe lining; and
cooling down so that the bonding sheet can not only adhere with the shoe surface and the shoe lining, but also can be sclerotic and shaped in the strengthened place between the shoe surface and the shoe lining.

10. A production device for producing bonding sheets that are made of hot-melt adhesive, comprises:
a male die having protruding parts with an bended surface that can produce bonding sheets;
a female die having cavities with an bended surface that can produce bonding sheets;
a female fixture die having cavities with a downward connecting through-hole underneath;
a male fixture die protruding parts which complies with the cavities of the female fixture die;
a first lifting device powered by a oil cylinder, coupled with the female fixture die and able to actuate the step-up & down of the female fixture die;
a second lifting device powered by a oil cylinder, coupled with the male fixture die and able to actuate the step-up & down of the male fixture die;
a heating plate placed on the female fixture die, useful for heating the female fixture die;
a horizontal movement device powered by the oil cylinder for actuating the female die and moving it toward the underside of the male die;
a mounting device powered by the oil cylinder for actuating the male die and mounting it with the female die; and
a cooling device on one side of the mounting device, for cooling down the bonding sheets inside the cavities of the female die.

11. The structure as claimed in claim 10, wherein the female die further comprises:
an upper half die having cavities penetrated, and the upper half die being actuated to step up and down by the oil cylinder of the third lifting device; and
a lower half die having cavities opened upward, the two cavities of the lower half die and the upper half die can be combined into a complete cavities for mounting the protruding parts of the male die.

12. The structure as claimed in claim 11, wherein a plurality springs set between the male die and the upper half die can force the upper half die to tightly close to the lower half die when the male die and the female die are mounting.

13. The structure as claimed in claim 10, wherein the cooling device further comprises a plurality cooling tubes, the cooling tubes of the cooling device are deployed on the male die and the female die and connected to a coolant flow container and a pump so that the pump can diverts the coolant flow from the container to the cooling tubes and can cools down the male die and the female die.

14. The structure as claimed in claim 10, wherein the cooling device further comprises a Nitrogen nozzle connected to a Nitrogen container and a pump, and the pump can spouts Nitrogen from the Nitrogen container and through the Nitrogen nozzle onto the male and female dies for cooling.

15. The structure of claim 3, wherein the polycaprolactone polymer has the formula: 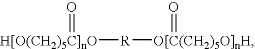
wherein R is an aliphatic hydrocarbon.

16. The structure of claim 1, wherein the hot-melt adhesive of the bonding sheet comprises an aliphatic polyester.

17. The method as claimed in claim 4, wherein the hot-melt adhesive of the bonding sheet comprises polycaprolactone polymer.

18. The method of claim 17, wherein the polycaprolactone polymer has the formula: 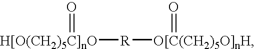
wherein R is an aliphatic hydrocarbon.

19. The method of claim 4, wherein the hot-melt adhesive of the bonding sheet comprises an aliphatic polyester.

20. The method of claim 19, wherein the aliphatic polyester has the formula: 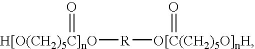
wherein R is an aliphatic hydrocarbon.

21. The method of claim 20, wherein the aliphatic polyester comprises a homopolymer of caprolactone initiated with a diol.
